(19) United States
(12) Patent Application Publication
(10) Pub. No.: US 2014/0115473 A1
(43) Pub. Date: Apr. 24, 2014

(54) APPARATUS AND METHOD FOR CONVERTING 2D CONTENT INTO 3D CONTENT, AND COMPUTER-READABLE STORAGE MEDIUM THEREOF

(71) Applicant: Oh-yun Kwon, Seoul (KR)

(72) Inventor: Oh-yun Kwon, Seoul (KR)

(73) Assignee: SAMSUNG ELECTRONICS CO., LTD., Suwon-si, Gyeonggi-do (KR)

(21) Appl. No.: 14/118,415

(22) PCT Filed: May 9, 2012
(86) PCT No.: PCT/KR2012/003643

§ 371 Date: Nov. 18, 2013

(30) Foreign Application Priority Data
May 17, 2011 (KR) 10-2011-0046349

(51) Int. Cl. H04N 13/00; G06F 3/0482

(52) U.S. Cl. CPC H04N 13/0029; G06F 3/0482
USPC 715/719; 348/43

(57) ABSTRACT

The method of converting 2D contents into 3D contents through a content converting apparatus includes: determining a quality of 3D contents to be converted from 2D contents that are video contents and include a plurality of frames; extracting an object from a frame among the plurality of frames; assigning depth to the extracted object; and performing rendering for conversion into 3D contents on the frame having the object assigned with the depth, wherein at least one of the extracting the object, the assigning the depth, and the performing the rendering is performed in accordance with the determined quality of 3D contents.

### TECHNICAL FIELD

Apparatuses and methods consistent with exemplary embodiments relate to an apparatus and method for converting contents, and a computer-readable medium thereof, and more particularly to an apparatus and method for converting two-dimensional (2D) contents into three-dimensional (3D) contents, and a computer-readable medium thereof.

### BACKGROUND ART

Video contents such as movies, dramas, sports, etc., are reproduced in a television, a personal computer, a smart phone, a smart pad, a portable multimedia player (PMP), an MP3 player, or the like display apparatus capable of reproducing contents.

With recent developments of display technologies for a three-dimensional (3D) image, such contents have been made into 3D contents and reproduced by a display apparatus capable of displaying a 3D image.

### DISCLOSURE OF INVENTION

### Technical Problem

However, there is a shortage of high quality 3D contents since a large scale apparatus and development manpower are needed and high costs and amounts of time are taken in order to make such 3D contents.

Also, in even the case of 3D contents being currently provided, only the 3D contents having a preset quality are used, and 3D contents having a variety of qualities catering to user's tastes are not available.

### Solution to Problem

Accordingly, one or more exemplary embodiments provide an apparatus and method capable of providing 3D contents having a variety of quality catering to user's tastes, and a computer-readable medium thereof.

According to an aspect of an exemplary embodiment, there is provided a method of converting two-dimensional (2D) contents into three-dimensional (3D) contents through a content converting apparatus, the method comprising determining a degree of performance of a plurality of different conversion processes; classifying a plurality of frames of the 2D contents as a plurality of frame groups corresponding to the plurality of conversion processes based on the determined degree of performance; performing the plurality of conversion processes corresponding to the plurality of classified frame groups; and merging the performance result of the plurality of conversion processes with respect to the plurality of frames.

The determining may include receiving a user's input regarding the degree of performance of the plurality of conversion processes; and determining the degree of performance of the plurality of conversion processes by the received user's input.

The determining may include displaying a graphic user interface (GUI) comprising a menu item for designating the degree of performance of the plurality of conversion processes; and determining the degree of performance of the plurality of conversion processes by a user's input through the menu item.

The determining may further include displaying information of a conversion quality corresponding to the degree of performance of the plurality of conversion processes.

The determining may further include displaying a GUI comprising a menu item of a conversion quality; and determining the degree of performance of the plurality of conversion processes by a user s input through the menu item of the conversion quality.

The plurality of conversion processes may include a first conversion process, and a second conversion process which corresponds to a lower conversion quality than the first conversion process.

The first conversion process may include at least one of an extraction of an object and an assignment of a depth which are performed by a user's input; and the second conversion process may include at least one of an interpolation and tracking which is performed by using the performance result of the first conversion process.

The classifying may include determining the frame group to which the first conversion process applies by down-sampling the plurality of frames at a sampling rate corresponding to the determined degree of performance of the first conversion process.

The classifying may include determining the frame group to which the first conversion process applies, among the plurality of frames based on a degree of importance corresponding to the determined degree of performance of the first conversion process.

According to an aspect of another exemplary embodiment, there is provided an apparatus for converting 2D contents into 3D contents, the apparatus comprising a converter which determines a degree of performance of a plurality of different conversion processes, classifies a plurality of frames of the 2D contents as a plurality of frame groups corresponding to the plurality of conversion processes based on the determined degree of performance, performs the plurality of conversion processes corresponding to the plurality of classified frame groups, and merges the performance result of the plurality of conversion processes with respect to the plurality of frame groups.

The apparatus may further include a user input unit which receives a user's input regarding the degree of performance of the plurality of conversion processes, wherein the converter determines the degree of performance of the plurality of conversion processes by the received user's input.

The apparatus may further include a display unit, wherein the converter displays on the display unit a GUI comprising a menu item for designating the degree of performance of the plurality of conversion processes, and determines the degree of performance of the plurality of conversion processes by a user's input through the menu item.

The converter may display on the display unit information of a conversion quality corresponding to the degree of performance of the plurality of conversion processes.

The converter may display on the display unit a GUI including a menu item of a conversion quality, and determines the degree of performance of the plurality of conversion processes by a user's input through a menu item of the conversion quality.

The plurality of conversion processes may include a first conversion process and a second conversion process which corresponds to a lower conversion quality than the first conversion process.

The first conversion process may include at least one of an extraction of an object and an assignment of a depth which are performed by a user's input, and the second conversion process comprises at least one of an interpolation and tracking which are performed by using the performance result of the first conversion process.

The converter may determine the frame group to which the first conversion process applies by down-sampling the plurality of frames at a sampling rate corresponding to the determined degree of performance of the first conversion process.

The converter determines the frame group to which the first conversion process applies among the plurality of frames based on a degree of importance corresponding to the determined degree of performance of the first conversion process.

### Advantageous Effects of Invention

Accordingly, one or more exemplary embodiments provide an apparatus and method capable of providing 3D contents having a variety of quality catering to user's tastes, and a computer-readable medium thereof.

### BRIEF DESCRIPTION OF DRAWINGS

The above and/or other aspects will become apparent and more readily appreciated from the following description of exemplary embodiments, taken in conjunction with the accompanying drawings, in which:

FIG. 1 is a block diagram showing a configuration of a content converting apparatus according to an exemplary embodiment;

FIG. 2 is a flowchart showing an operation of a content converting apparatus according to an exemplary embodiment;

FIG. 3 is a flowchart showing an operation of a content converting apparatus according to another exemplary embodiment;

FIG. 4 is a table showing an example of plural quality modes in a content converting apparatus according to an exemplary embodiment;

FIG. 5 is a flowchart showing an operation of a content converting apparatus according to still another exemplary embodiment;

FIG. 6 is a flowchart showing an operation of a content converting apparatus according to still another exemplary embodiment;

FIG. 7 illustrates an example of a graphic user interface (GUI) including a menu item provided by the content converting apparatus in FIG. 1;

FIG. 8 is a flowchart showing a detailed operation of the content converting apparatus which is explained by referring to FIGS. 6 and 7;

FIGS. 9 and 10 are an example of extracting an object and assigning depth by a user's input by the content converting apparatus in FIG. 1; and

FIG. 11 is a flowchart showing a detailed operation of the content converting apparatus which is explained by referring to FIGS. 6 and 7.

### BEST MODE FOR CARRYING OUT THE INVENTION

Below, exemplary embodiments will be described in detail with reference to accompanying drawings. Hereinafter, expressions such as “at least one of” when preceding a list of elements, modify the entire list of elements and do not modify the individual elements of the list.

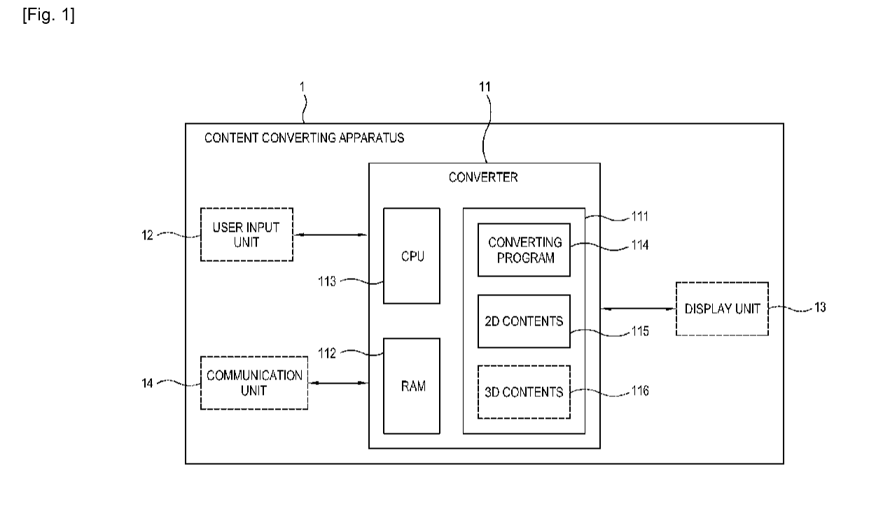

FIG. 1 is a block diagram showing a configuration of a content converting apparatus 1 according to an exemplary embodiment. The content converting apparatus 1 converts two-dimensional (2D) contents into three-dimensional (3D) contents. In the present exemplary embodiment, the contents include moving picture contents, for example, movies, dramas, sports, etc.

The content converting apparatus 1 may receive 2D contents to be converted into 3D contents from a predetermined 2D content provider (not shown). The content converting apparatus 1 may receive 2D contents from the 2D content provider through a predetermined network (not shown). For example, the 2D content provider may be a network server which stores 2D contents and transmits the 2D contents to the content converting apparatus 1 as requested by the content converting apparatus 1.

According to another exemplary embodiment, the content converting apparatus 1 may receive 2D content from the 2D content provider through a data transfer method or mechanism other than the network. For example, the 2D content provider may be a device provided with a storage unit such as a hard disk, a flash memory, etc., for storing 2D contents, which is locally connected to the content converting apparatus 1 and transmits 2D contents to the content converting apparatus 1 as requested by the content converting apparatus 1. In this case, there is no limit to a method of locally connecting the content converting apparatus 1 and the 2D content provider as long as the method is for transmitting data of 2D contents. For example, the local connection method may include universal serial bus (USB) or the like.

According to still another exemplary embodiment, the content converting apparatus 1 may receive 2D contents from a 3D content provider (not shown). For example, the 3D content provider may transmit 2D content to the content converting apparatus 1, receive 3D contents converted by the content converting apparatus 1, and provide the received 3D contents to a predetermined user terminal (not shown). The user terminal is capable of displaying 3D contents received from the content converting apparatus 1 as 3D image. For example, the user terminal may include a television (TV), a personal computer (PC), a smart phone, a smart pad, a PMP, an MP3 player, etc.

According to still another exemplary embodiment, the content converting apparatus 1 may transmit the converted 3D contents to the user terminal capable of displaying the 3D contents as a 3D image. For example, the content converting apparatus 1 may provide 3D contents to the user terminal through a network.

In the network according to the present exemplary embodiment, there is no limit to a network communication method such as a wired and/or wireless communication method as long as the method is for data communication to transmit at least one of 2D contents and 3D contents. The network communication method includes any known communication methods.

As shown in FIG. 1, the content converting apparatus 1 may include a converter 11 and a communication unit 14. The converter 11 converts 2D contents into 3D contents. The 2D contents include a plurality of video frames (hereinafter, referred to as a ‘frame’). The 3D contents are based on a viewer's binocular parallax, which may include a plurality of left-eye frames and a plurality of right-eye frames. Among the plurality of left-eye frames and the plurality of right-eye frames, a pair including a left-eye frame and a right-eye frame may be respectively converted from at least one corresponding frame among the plurality of frames of the 2D contents. The conversion from 2D contents into 3D contents (hereinafter, referred to as ‘2D-3D conversion’), performed by the converter 11, will be described in detail below.

The communication unit 14 may perform at least one of data communication between the 2D content provider and the content converting apparatus 1, data communication between the 3D content provider and the content converting apparatus 1, and data communication between the user terminal and the content converting apparatus 1.

The converter 11 may include a storage unit 111, a random access memory (RAM) 112, and a central processing unit (CPU) 113. The storage unit 111 may store a converting program 114 for performing 2D-3D conversion, 2D contents 115 to be converted, and 3D contents 116 converted from 2D contents. The storage unit 111 may be achieved by a non-volatile memory such as a hard disk, a flash memory, etc. The RAM 112 is loaded with at least a part of the converting program 114 when the converter 11 operates, and the CPU 113 executes the converting program 114 loaded into the RAM 112. The converting program 114 has instructions executable by the CPU 113. The storage unit 111 is an example of a computer-readable storage medium.

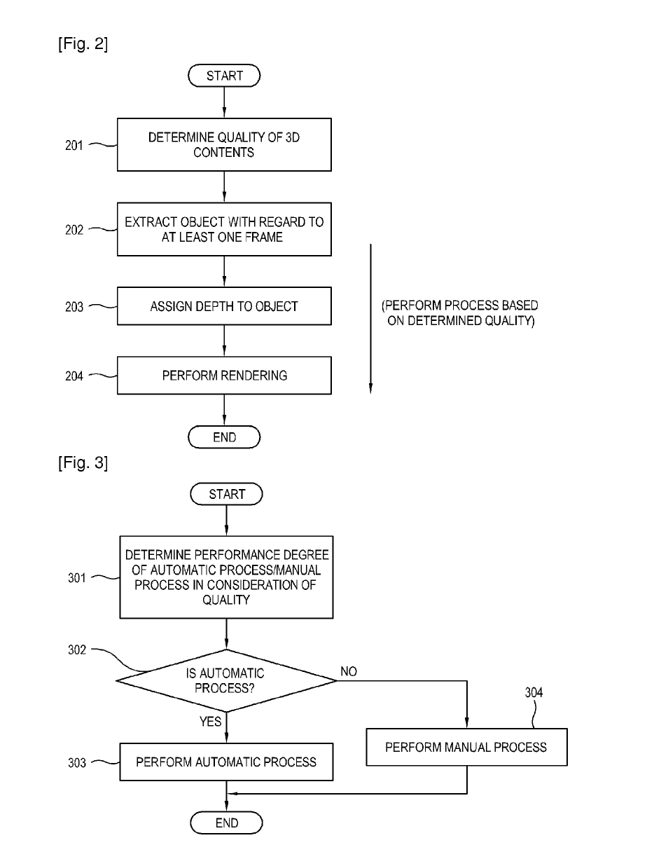

FIG. 2 is a flowchart showing an operation of a content converting apparatus 1 according to an exemplary embodiment. The operation (hereinafter, referred to as a ‘2D-3D converting process’) of the content converting apparatus 1 may correspond to a content converting method performed by instructions of the converting program 114. In the present exemplary embodiment, the 2D-3D converting process may include a 3D-content quality determination operation 201, an object extraction operation 202, a depth assignment operation 203, and a rendering operation 204.

First, in the 3D-content quality determination operation 201, the quality of 3D contents to be converted is determined. In the present exemplary embodiment, the 2D-3D converting process may be performed in accordance with the quality of 3D contents. That is, at least one of the object extraction operation 202, the depth assignment operation 203, and the rendering operation 204 may be performed on the basis of the determined quality of 3D contents. The 3D-content quality determination operation 201 will be described below in more detail.

In the object extraction operation 202, an object to which a 3D effect will be reflected is extracted with regard to an image of the frame to be processed. The object may be a main image contained in the scene of each frame and, for example, may be an image of a main character in a scene where the main character appears, an image of a vehicle in a scene where a vehicle moves, etc. In the object extraction operation 202, an image of a corresponding frame is segmented so that a boundary of an object can be extracted from segmentation results.

In the depth assignment operation 203, depth is assigned to the object extracted by the object extraction operation 202. The depth is a parameter for realizing a 3D visual effect, which is used for shifting the object leftward and rightward by an assigned parameter in generated corresponding left-eye and right-eye frames. In the depth assignment operation 203, a previously given standardized template may be used for depth assignment.

In the rendering operation 204, image processing for a completed 3D image is performed with regard to the left-eye and right-eye frames resulting from the depth assignment operation 203. For example, the rendering operation 204 may include a process for filling a blank area generated as an object is shifted in an image of a frame (i.e., inpainting), etc.

Below, the 3D-content quality determination operation 201 will be described in detail. At least one operation among the 2D-3D converting process operation according to an exemplary embodiment may include a manual operation implemented in accordance with a user's input, and an automatic operation implemented in accordance with preset reference information. For example, in the object extraction operation 202, the depth assignment operation 203, or the like operations, some frames may be processed by manual operations while other frames may be processed by automatic operations.

In the manual operations, the converting process operations may be performed in accordance with an input of a user (or a developer of performing a content converting operation). The content converting apparatus 1 may further include a user input unit 12 such as a keyboard, a mouse, a tablet, etc., for the input of a user. Also, the content converting apparatus 1 may further include a display unit 13 such as a monitor or the like that displays an image being converted so that a user can observe a progression of the converting process. In order to receive a user's input effectively, the content converting apparatus 1 may display a graphic user interface (GUI, not shown) containing an image of a processed frame, a predetermined input menu, etc., on the display unit 13. A user may enter an input for the converting process through the input menu or the like of the GUI while ascertaining an image of a frame displayed on the display unit 13. For instance, a user may enter an input for extracting an object through the input menu or the like of the GUI while ascertaining the object contained in an image of a frame.

In the automatic operations, the operations are performed on the basis of the preset reference information. For example, in the object extraction operation 202, the content converting apparatus 1 may analyze an image of a frame and select an object, of which variation in a pixel value on a boundary of a certain object within the image is equal to or higher than a predetermined threshold value, as an object to be extracted. Here, the reference information may be a threshold value for the variation in the pixel value on the boundary of the object, by which the object can be selected to be extracted.

In a certain 2D-3D converting process, the quality of 3D contents may indicate how much percentage each of the manual operations and the automatic operations are. For example, in the object extraction operation 202, the manual operations and the automatic operations may each constitute half of the object extraction operation 202. The quality of 3D contents may be represented as a proportion (hereinafter, referred to as a ‘combination proportion’ or ‘performance degree’) of the automatic operations (or the manual operations) in the whole of a certain 2D-3D converting process operation.

FIG. 3 is a flowchart showing an operation of a content converting apparatus 1 according to another exemplary embodiment. First, the content converting apparatus 1 determines the performance degree of the automatic operation (or the manual operation) in consideration of the quality of 3D contents at operation 301. Next, in a certain 2D-3D converting process, whether to perform the automatic operation or the manual operation is determined on the basis of the determined performance degree at operation 302. In operation 302, whether to perform the automatic operation or the manual operation may be determined per frame. If it is determined to perform the automatic operation, the corresponding 2D-3D converting process operation is performed by the automatic operation at operation 303. On the other hand, if it is determined to perform the manual operation, the corresponding 2D-3D converting process operation is performed by the manual operation at operation 304.

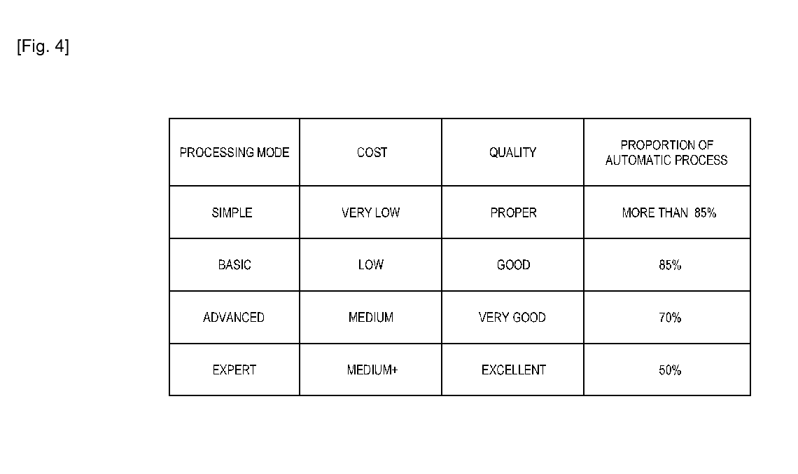

The quality of 3D contents may include a plurality of quality modes. Thus, the 2D-3D converting process may be performed corresponding to one selected among the plurality of quality modes. FIG. 4 is a table showing an example of plural quality modes in a content converting apparatus 1 according to an exemplary embodiment. As shown in FIG. 4, the plurality of quality modes may include a simple mode, a basic mode, an advanced mode and an expert mode in order of high quality. For example, these quality modes may have performance percentages of the automatic operations of more than 85%, 85%, 70% and 50%, respectively, in the whole corresponding operation. Also, the plurality of quality modes may correspond to costs in light of producing the 3D contents (refer to ‘very low,’ ‘low,’ ‘medium’ and ‘medium+’ in the table of FIG. 4).

The quality of 3D contents may be determined in accordance with the kinds or formats of 2D contents. For example, if the 2D contents are recently released movies, relatively high quality may be determined for the 2D contents. On the other hand, if the 2D contents are old movies, relatively low quality may be determined for the 2D contents. According to another exemplary embodiment, if the movie is a grand scale blockbuster, relatively high quality may be determined for the movie. On the other hand, the relatively low quality may be determined for a story-oriented movie. According to still another exemplary embodiment, the quality of 3D contents may be determined in accordance with genres of contents such as sports, movies, drama, etc.

The quality of 3D contents may be determined in accordance with a user's input. The user's input for determining the quality of 3D contents may be received through the user input unit 12. In this case, a user may be, for example, a developer who develops the conversion of the corresponding contents. Alternatively, the display unit 13 may display an input menu as a GUI for determining the quality of 3D contents. For example, the input menu for determining the quality of 3D contents may include a pull-down menu having GUI items corresponding to a ‘simple mode,’ a ‘basic mode,’ a ‘ advanced mode,’ and an ‘expert mode,’ respectively. If one is selected among the plural GUI items of the pull-down menu, only the GUI items having operations used for the selected quality mode may be activated among the plural GUI items included in the GUI input menu corresponding to each 2D-3D converting process, and GUI items corresponding to unnecessary operations may be inactivated.

Alternatively, the user's input for determining the quality of 3D contents may be received, via the communication unit 14, from another device, e.g., a user terminal (not shown), requesting the 3D contents to be converted. In this case, a user may be, for example, a user who requests the corresponding contents to be converted and uses the converted 3D contents.

As described above, according to an exemplary embodiment, 3D contents to be converted are provided with a variety of qualities, so that the contents having effective quality against costs can be provided while catering to user's various tastes.

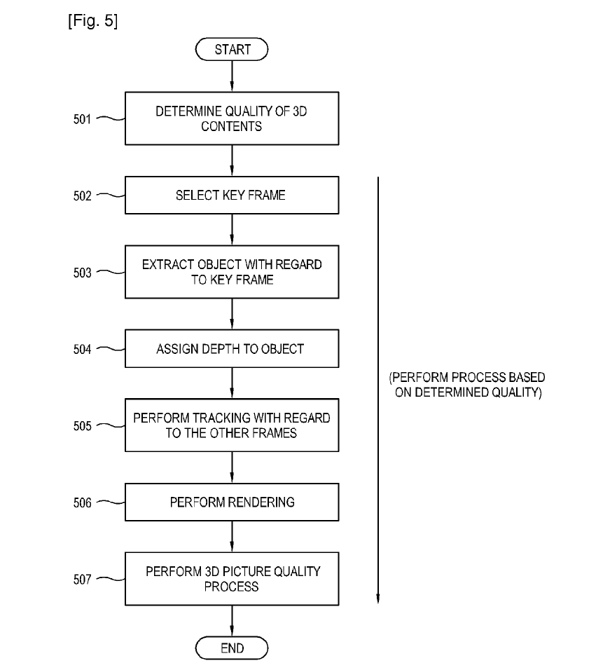

FIG. 5 is a flowchart showing an operation of a content converting apparatus 1 according to still another exemplary embodiment. Regarding the content converting apparatus 1 described with reference to FIG. 5, the same or similar configurations as the content converting apparatus 1 described with reference to FIGS. 1 to 3 will be omitted.

The 2D-3D converting process operations in the present exemplary embodiment may include a 3D-content quality determination operation 501, a key frame selection operation 502, an object extraction operation 503, a depth assignment operation 504, a tracking operation 505, a rendering operation 506 and a 3D picture quality operation 507.

In the 3D-content quality determination operation 501, the quality of 3D contents to be converted is determined. As the key frame, a frame representing contents of an image may be selected among the plural frames of the 2D contents. For example, the key frame may include a frame where a scene is switched, a frame where a main character of a scene is closed up, etc. The key frame may be selected on the basis of motion of an image in the corresponding frame. For example, a frame of which motion of an image is equal to or higher than a predetermined value may be selected as the key frame.

In the object extraction operation 503, an object to which a 3D effect will be reflected is extracted with regard to the selected key frame. In the depth assignment operation 504, depth is assigned to the object extracted in the object extraction operation 503.

In the tracking operation 505, a left-eye frame and a right-eye frame are generated corresponding to other frames other than the key frame. The tracking 505 may be performed with reference to the object extraction operation 503 and the depth assignment operation 504 performed for the key frame 302. As described above, the object extraction operation 503 and the depth assignment operation 504 are performed for an important key frame and the tracking is performed for the other frames with reference to the key frame, so that the converting process is effective in cost and time can be performed while keeping high quality.

In the rendering operation 506, image processing for a completed 3D image is performed with regard to the left-eye and right-eye frames resulting from the depth assignment operation 504 and the tracking operation 505.

In the 3D picture quality operation 507, the 3D picture quality process is performed with regard to the frames resulting from the rendering operation 506. The 3D picture quality operation 507 may include at least one of contrast enhancement, detail enhancement, etc. Through the 3D picture quality operation 507, improvement of picture quality can be achieved when the 3D contents are actually displayed, so that the picture quality can be optimized to a display apparatus.

In addition, according to the present exemplary embodiment, at least one of the 2D-3D converting process operation may be performed on the basis of information about contents and developments of a scene of a frame to be processed (hereinafter, referred to as ‘storytelling information’). The storytelling information is information to be used in realizing 3D visual effects corresponding to story development of contents in accordance with an intention of a content producer. In the present exemplary embodiment, the object extraction operation 503, the depth assignment operation 504, or the like operations may be performed on the basis of the storytelling information. As an example of using the storytelling information, in a scene where two characters have a dialogue with each other, if another main character passes behind the two characters, this main character may be extracted as an object of a corresponding frame, or depth may be fully applied to the extracted object of this main character. In this example, the storytelling information may include information about an image of another main character to extract an object, or a vale representing an importance degree on story development to assign the depth, etc., which may be previously provided corresponding to a relevant frame and stored in the storage unit 111. The converter 11 may perform an operation with reference to the storytelling information stored in the storage unit 111.

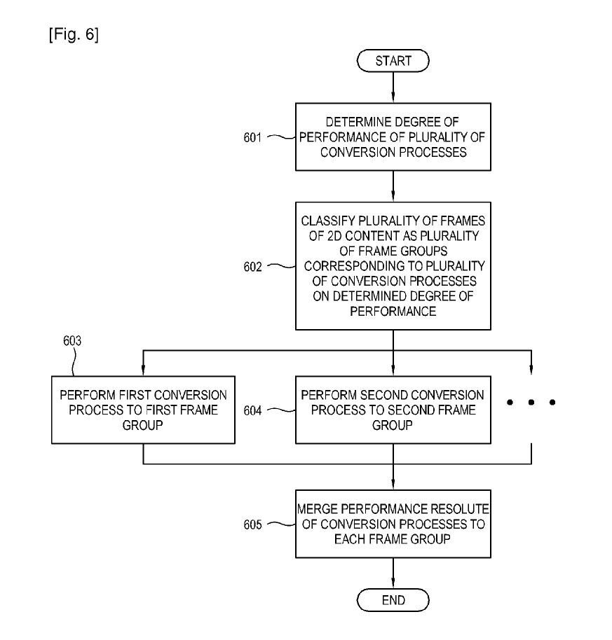

FIG. 6 is a flowchart showing an operation of a content converting apparatus according to still another exemplary embodiment. Elements of the content converting apparatus 1 in FIG. 6 which are the same as or similar to those of the content converting apparatus 1 in FIGS. 1 to 5 will not be explained repetitively. At operation 601, the content converting apparatus 1 determines the degree of performance of a plurality of conversion processes which will apply to the conversion from 2D to 3D.

The plurality of conversion processes according to the present exemplary embodiment may include a first conversion process through which a quality of the converted 3D content is relatively higher (hereinafter, to be called ‘conversion quality’), and a second conversion process through which a conversion quality of relatively lower. For example, the first conversion process includes a process of extracting an object or assigning a depth by a user's input. The second conversion process includes a process of interpolating frames by using the performance result of the first conversion process or performing a tracking. However, the first and second conversion processes are not limited to the foregoing and may include various types of conversion processes with different conversion qualities. Further, the plurality of conversion processes may include three or more conversion processes but not limited to the two conversion processes. At operation 601, the content converting apparatus 1 may determine the degree of performance of the plurality of conversion processes by a user's input. For example, the content converting apparatus 1 may receive a user's input regarding the degree of performance of the plurality of conversion processes through the user input unit 12 and then determine the degree of performance of each conversion process by the received user's input.

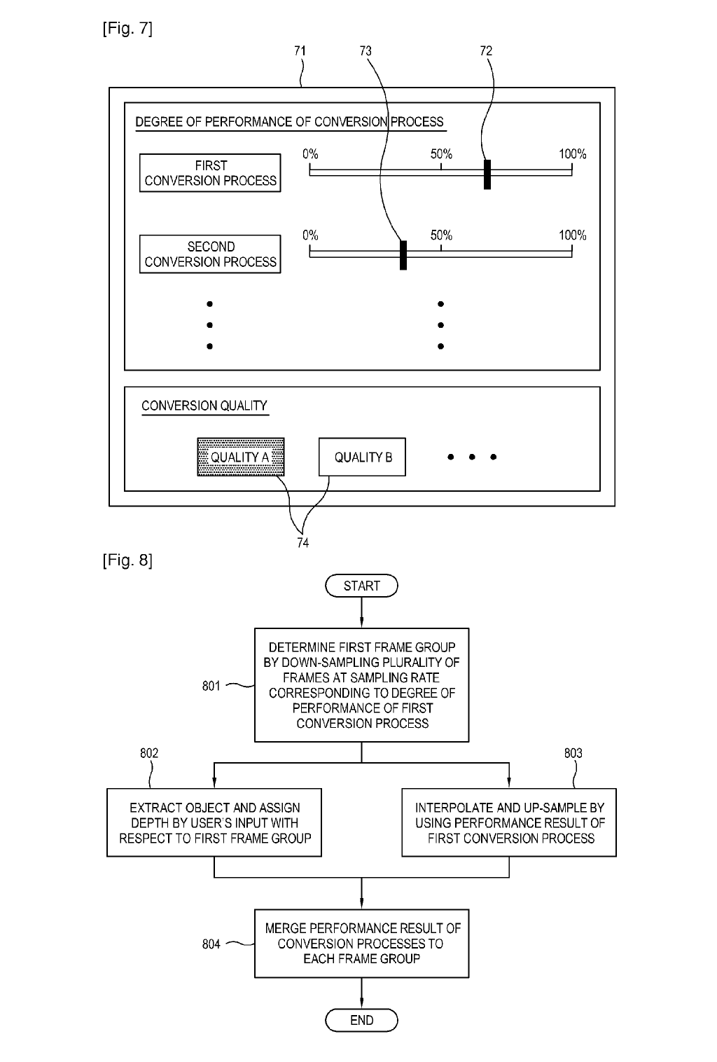

The content converting apparatus 1 may display a graphic user interface (GUI) including a menu item to designate the degree of performance of the plurality of conversion processes and determine the degree of performance of the plurality of conversion processes by a user's input through the menu item. FIG. 7 illustrates an example of such GUI including the menu item. A GUI 71 includes menu items 72 and 73 which are used to designate the degree of performance of each conversion process (first conversion process, second conversion process, etc.). The menu items 72 and 73 may be shaped like a slide bar as shown in FIG. 7. A ser may use the menu items 72 and 73 to designate the degree of performance of the plurality of conversion processes (first conversion process, second conversion process, etc.). However, the shape of the interface which is used to designate the degree of performance of the plurality of conversion processes is not limited to that shown in FIG. 7, and may include various types of interfaces, e.g., direct input, selection icon, etc. which may be used to designate the degree of performance by a user's input.

A user may designate the degree of performance of the plurality of conversion processes (first conversion process, second conversion process, etc.) in consideration of the conversion quality. If the first conversion process corresponds to a higher conversion quality and the second conversion process corresponds to a lower conversion quality than the first conversion quality and if a user desires to improve the conversion quality, a user may designate the degree of performance of the first conversion process to be higher than the degree of performance of the second conversion process (or designate the degree of performance of the second conversion process to be lower than the degree of performance of the first conversion process). For example, a user may designate the first conversion process to be 60% and designate the second conversion process to be 30%. On the contrary, if a user desires to lower the conversion quality, a user may designate the degree of performance of the first conversion process to be lower than the degree of performance of the second conversion process (or designate the degree of performance of the second conversion process to be higher than the degree of performance of the first conversion process). For example, a user may designate the degree of performance of the first conversion process to be 30% and designate the degree of performance of the second conversion process to be 60%.

The content converting apparatus 1 may display information of an expected conversion quality corresponding to the designated degree of performance of the plurality of conversion processes (first conversion process, second conversion process, etc.). The information of the conversion quality may be displayed as a menu item 74 showing a plurality of quality modes as shown in FIG. 7. The plurality of quality modes may be arranged in the order of high quality like ‘Quality A’, ‘Quality B’, etc. The content converting apparatus 1 highlights the menu item 74 of the expected conversion quality corresponding to the designated degree of performance of the plurality of conversion processes. In FIG. 7, the expected conversion quality corresponding to the designated degree is Quality A which is highest.

According to another exemplary embodiment, the content converting apparatus 1 may enable a user to select the menu item 74 by his/her input. A user may select the conversion quality through the menu item 74 rather than through the menu items 72 and 73, and the content converting apparatus 1 may determine the degree of performance of the plurality of conversion processes corresponding to the selected conversion quality. For example, if a user selects the menu item 74 falling under Quality B, the content converting apparatus 1 may determine that a user has selected the second highest conversion quality and designate the degree of performance of the first conversion process to be 40% and designate the degree of performance of the second conversion process to be 50%. The figure of the degree of performance stated in the present exemplary embodiment is an example and such figure may vary in reality.

Returning to FIG. 6, if the degree of performance of the plurality of conversion processes is determined at operation 601, the content converting apparatus 1 classifies a plurality of frames of a 2D content which is to be converted, as a plurality of frame groups corresponding to the plurality of conversion processes based on the determined degree of performance at operation 602. If the plurality of conversion processes includes the first and second conversion processes, the content converting apparatus 1 may classify the plurality of frames of a 2D content as a first gram group to which the first conversion process applies, and a second frame group to which the second conversion process apples. In classifying the plurality of frames of the 2D content, the content converting apparatus 1 considers the degree of performance of the plurality of conversion processes determined at operation 601. For example, if the degree of performance of the first conversion process is determined to be 70% and the degree of performance of the second conversion process is determined to be 30%, the content converting apparatus 1 may classify 70% of the entire frames of the 2D content as the first frame group, 30% as the second frame group.

The content converting apparatus 1 performs the plurality of conversion processes corresponding to the plurality of classified frame groups. That is, the first conversion process is performed to the first frame group (operation 603), and the second conversion process is performed to the second frame group (operation 604).

At operation 605, the content converting apparatus 1 combines the performance result of the conversion processes with respect to each frame group. Conversion into 3D may be completed or further conversion processes may be performed by such combination.

FIG. 8 is a flowchart showing a detailed operation of the content converting apparatus 1 which is explained by referring to FIGS. 6 and 7. The content converting apparatus 1 may select a first frame group according to a predetermined standard to which the conversion process corresponding to a relatively higher conversion quality applies. At operation 801, the content converting apparatus 1 may determine the first frame group by down-sampling the plurality of frames at a sampling rate corresponding to the determined degree of performance of the first conversion process. The down-sampling may be performed at a sampling rate of 1/n (n=1, 2, 3,) with respect to entire frames. For example, if the first conversion process has the degree of 50%, the first frame group may be determined by down-sampling the frames at a sample rate of 1/2. In this case, half of the entire frames may be selected as the first frame group.

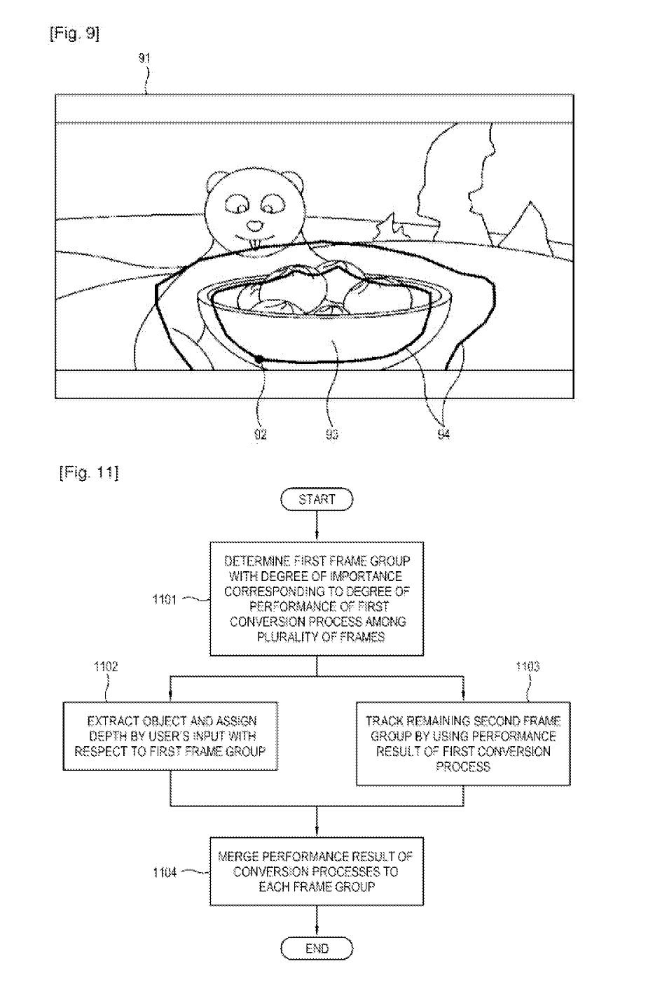

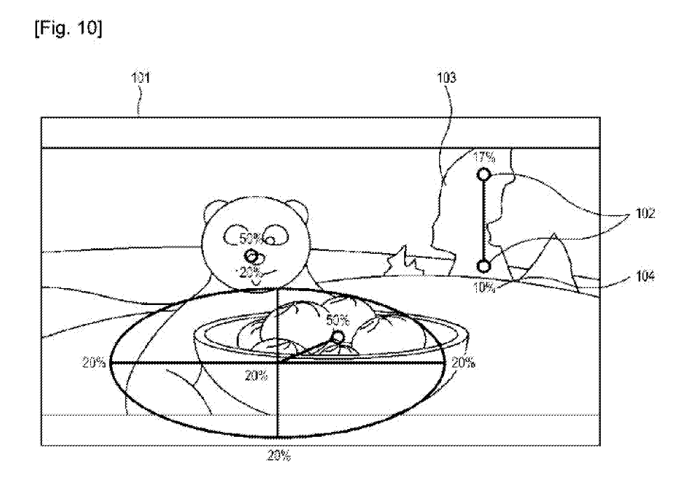

At operation 802, the content converting apparatus 1 may extract an object and assign a depth to the determined first frame group by a user's input. The content converting apparatus 1 may sequentially display the frames selected as the first frame group, and provide a GUI for extracting the object and assigning the depth. The content converting apparatus 1 may extract the object and assign the depth by a user's input through the GUI. FIG. 9 illustrates an example of extracting an object by a user's input. A user may draw a line 94 which indicates a boundary of an object 93 through the user input unit 12 by using a GUI 92. The content converting apparatus 1 may refer to the line 94 drawn by the user's input and extract the object 93 having the boundary shown as the line 94. FIG. 10 illustrates an example of assigning a depth by a user's input. A user may designate a value 104 of a depth to be assigned to an object 103 by using a GUI 102 with respect to the object 103 within a frame 101. The content converting apparatus 1 may assign the depth to the object 103 by referring to the value 104 provided by the user's input. The content converting apparatus 1 ends the operation 802 when the object has been extracted and the depth has been assigned to such object within all frames selected as the first frame group.

At operation 803, the content converting apparatus 1 performs an interpolation operation and an up-sampling operation by using the performance result of the first conversion process (operation 802). Since the extraction of the object and assignment of depth has been performed to a part of frames of the 2D content (first frame), such extraction and assignment should be performed to the remaining frames. The content converting apparatus 1 extracts an object and assigns a depth to the remaining frames by using the result of the extraction of the object and assignment of the depth to the first frame group performed at operation 802. The up-sampling at operation 803 is performed at a sampling rate corresponding to the down-sampling performed at operation 801. For example, if the down-sampling has been performed at a sampling rate of 1/2 at operation 801, the up-sampling is performed at a sample rate of 2 at operation 803. The extraction of the object and assignment of depth to the up-sampled frame is performed by interpolating the result of the extraction of the object and assignment of depth to at least one frame of the first frame group which is adjacent to a frame to which such extraction and assignment is performed. If the interpolation for the up-sampled frames is finished, the content converting apparatus 1 ends the operation 803.

At operation 804, the content converting apparatus 1 merges the first frame group to which extraction of the object and the assignment of depth has been performed at operation 802, and the frame which has been interpolated and up-sampled at operation 803. The merged frame may be rendered and processed in other ways, as explained above with reference to FIGS. 1 to 5.

FIG. 11 is a flowchart showing a detailed operation of the content converting apparatus 1 which is explained by referring to FIGS. 6 and 7. The content converting apparatus 1 may select the first frame group according to another standard to which the first conversion process corresponding to the relatively higher conversion quality applies. At operation 1101, the content converting apparatus 1 may determine the first frame group with a degree of importance corresponding to the degree of performance of the first conversion process determined at operation 601, among the plurality of frames of the 2D content. The degree of importance corresponds to the degree of representation of an image among the plurality of frames. For example, a frame in which a scene is changed, a frame in which a main character is closed-up may have a high degree of importance. The degree of importance may be determined by the degree of change in a motion of the image in the frame. The content converting apparatus 1 may determine that the frame in which a motion of an image in the concerned frame is a value or higher corresponding to the degree of performance of the first conversion process determined at operation 601 is the first frame group. For example, if the degree of performance of the first conversion process is designated to be 50%, the frame which falls under top 1/2 of the entire frames in the order of degree of importation may be determined as the first frame group.

At operation 1102, the content converting apparatus 1 may extract an object and assign a depth to the determined first frame group by a user's input. The content converting apparatus 1 may sequentially display the frame selected as the first frame group, and extract the object and assign the depth to the object by a user's input. The operation 1102 may be performed similarly to the operation 802 which has been explained above. If the extraction of the object and the assignment of depth with respect to the frame selected as the first frame group has been completed, the content converting apparatus 1 ends the operation 1102.

At operation 1103, the content converting apparatus 1 performs a tracking by using the result of the performance of the first conversion process (operation 1102). Since the extraction of the object and the assignment of depth has been performed to a part of frames of the 2D content (first frame), such extraction and assignment should be performed to the remaining frames. The content converting apparatus 1 extracts the object and assigns the depth to the object with respect to the remaining frames by performing the tracking with the result of the extraction and assignment which has been performed to the first frame group at operation 1102. The tracking at the operation 1103 may be performed similarly to the tracking at the operation 505 which has been explained above. If the tracking of the frames of the 2D content excluding the first frame group has been completed, the content converting apparatus 1 ends the operation 1103.

At operation 1104, the content converting apparatus 1 merges the first frame group to which the extraction of the object and the assignment of depth to the object has been performed at the operation 1102, and the frame which has been tracked at the operation 1103. The merged frame may be rendered and processed in other ways, as explained above with reference to FIGS. 1 to 5.

As described above, it is possible to provide 3D contents having a variety of qualities catering to users' tastes.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the content converting apparatus 1 can include a processor or microprocessor executing a computer program stored in a computer-readable medium.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents. For example, in the foregoing exemplary embodiments, the quality of 3D contents varies with regard to the operations such as the object extraction operation 202, the depth assignment operation 203, etc., although another exemplary embodiment is not limited thereto. For example, according to one or more other exemplary embodiments, different operations such as the key frame selection operation 502, the rendering operation 506, etc., may be performed in accordance with the quality of 3D contents.

1. A method of converting two-dimensional (2D) contents into three-dimensional (3D) contents through a content converting apparatus, the method comprising: determining a degree of performance of a plurality of different conversion processes; classifying a plurality of frames of the 2D contents as a plurality of frame groups corresponding to the plurality of conversion processes based on the determined degree of performance; performing the plurality of conversion processes corresponding to the plurality of classified frame groups; and merging the performance result of the plurality of conversion processes with respect to the plurality of frames.

2. The method according to claim 1, wherein the determining comprises receiving a user's input regarding the degree of performance of the plurality of conversion processes; and determining the degree of performance of the plurality of conversion processes by the received user's input.

3. The method according to claim 2, wherein the determining comprises displaying a graphic user interface (GUI) comprising a menu item for designating the degree of performance of the plurality of conversion processes; and determining the degree of performance of the plurality of conversion processes by a user's input through the menu item.

4. The method according to claim 1, wherein the determining further comprises displaying information of a conversion quality corresponding to the degree of performance of the plurality of conversion processes.

5. The method according to claim 4, wherein the determining further comprises displaying a GUI comprising a menu item of a conversion quality; and determining the degree of performance of the plurality of conversion processes by a user's input through the menu item of the conversion quality.

6. The method according to claim 1, wherein the plurality of conversion processes comprises a first conversion process, and a second conversion process which corresponds to a lower conversion quality than the first conversion process.

7. The method according to claim 6, wherein the first conversion process comprises at least one of an extraction of an object and an assignment of a depth which are performed by a user's input; and the second conversion process comprises at least one of an interpolation and tracking which is performed by using the performance result of the first conversion process.

8. The method according to claim 6, wherein the classifying comprises determining the frame group to which the first conversion process applies by down-sampling the plurality of frames at a sampling rate corresponding to the determined degree of performance of the first conversion process.

9. The method according to claim 6, wherein the classifying comprises determining the frame group to which the first conversion process applies, among the plurality of frames based on a degree of importance corresponding to the determined degree of performance of the first conversion process.

10. An apparatus for converting 2D contents into 3D contents, the apparatus comprising: a converter which determines a degree of performance of a plurality of different conversion processes, classifies a plurality of frames of the 2D contents as a plurality of frame groups corresponding to the plurality of conversion processes based on the determined degree of performance, performs the plurality of conversion processes corresponding to the plurality of classified frame groups, and merges the performance result of the plurality of conversion processes with respect to the plurality of frame groups.

11. The apparatus according to claim 10, further comprising a user input unit which receives a user's input regarding the degree of performance of the plurality of conversion processes, wherein the converter determines the degree of performance of the plurality of conversion processes by the received user's input.

12. The apparatus according to claim 11, further comprising a display unit, wherein the converter displays on the display unit a GUI comprising a menu item for designating the degree of performance of the plurality of conversion processes, and determines the degree of performance of the plurality of conversion processes by a user's input through the menu item.

13. The apparatus according to claim 10, wherein the converter displays on the display unit information of a conversion quality corresponding to the degree of performance of the plurality of conversion processes.

14. The apparatus according to claim 13, wherein the converter displays on the display unit a GUI comprising a menu item of a conversion quality, and determines the degree of performance of the plurality of conversion processes by a user's input through a menu item of the conversion quality.

15. The apparatus according to claim 10, wherein the plurality of conversion processes comprises a first conversion process and a second conversion process which corresponds to a lower conversion quality than the first conversion process.

16. The apparatus according to claim 15, wherein the first conversion process comprises at least one of an extraction of an object and an assignment of a depth which are performed by a user's input, and the second conversion process comprises at least one of an interpolation and tracking which are performed by using the performance result of the first conversion process.

17. The apparatus according to claim 15, wherein the converter determines the frame group to which the first conversion process applies by down-sampling the plurality of frames at a sampling rate corresponding to the determined degree of performance of the first conversion process.

18. The apparatus according to claim 15, wherein the converter determines the frame group to which the first conversion process applies among the plurality of frames based on a degree of importance corresponding to the determined degree of performance of the first conversion process.
